(19) United States
(12) Patent Application Publication
(10) Pub. No.: US 2026/0222837 A1
(43) Pub. Date: Jul. 30, 2026

(54) METHOD AND APPARATUS OF SUPPORTING ARTIFICIAL INTELLIGENCE

(71) Applicant: Lenovo (Beijing) Limited, Beijing (CN)

(72) Inventors: Jianfeng Wang, Beijing (CN); Bingchao Liu, Beijing (CN); Congchi Zhang, Shanghai (CN)

(73) Assignee: Lenovo (Beijing) Limited, Beijing (CN)

(21) Appl. No.: 19/143,680

(22) PCT Filed: Dec. 29, 2022
(86) PCT No.: PCT/CN2022/143344

§ 371 Date: Jun. 26, 2025

(51) Int. Cl. H04W 24/02

(52) U.S. Cl. CPC H04W 24/02

(57) ABSTRACT

Embodiments of the present application relate to a method and apparatus of supporting artificial intelligence (AI). An exemplary method includes: deploying at least one AI model, wherein a status of each AI model includes one of active status, inactive status or idle status; monitoring an AI model of the at least one AI model, wherein, the AI model is in the active status or the inactive status; and switching the status of the AI model based on results of monitoring.

### TECHNICAL FIELD

Embodiments of the present application are related to wireless communication technology, especially, related to artificial intelligence (AI) application in wireless communication, e.g., a method and apparatus of supporting AI.

### BACKGROUND OF THE INVENTION

AI, at least including machine learning (ML) is used to learn and perform certain tasks via training neural networks (NNs) with vast amounts of data, which is successfully applied in computer vison (CV) and nature language processing (NLP) areas. Deep learning (DL), which is a subordinate concept of ML, utilizes multi-layered NNs as an “AI model” (or “AI/ML model” or “model” etc.) to learn how to solve problems and/or optimize performance from vast amounts of data.

If AI models used on AI-based methods are well trained, the AI-based methods can obtain better performance than traditional methods. Thus, 3rd generation partnership program (3GPP) has been considering to introduce AI into 3GPP since 2016, including several study items and work items in SA1, SA2, SA5 and radio access network (RAN)3.

When there are multiple AI models deployed in a device, e.g., a user equipment (UE), it is necessary to activate the corresponding AI models for different purposes, e.g., inference and monitoring, considering the performance requirement, computation power, battery and so on.

Therefore, the industry desires technical solutions of managing AI models and status switching, especially for air interface.

### SUMMARY

An objective of the embodiments of the present application is at least to provide a technical solution for wireless communication, especially for supporting AI in wireless communication, which provides enhancements on air interface to support AI model status switching.

Some embodiments of the present application provide an apparatus of supporting AI, e.g., a UE, which includes: a transceiver; and a processor coupled to the transceiver, wherein the processor is configured to: deploy at least one AI model, wherein a status of each AI model includes one of active status, inactive status or idle status; monitor an AI model of the at least one AI model, wherein, the AI model is in the active status or the inactive status; and switch the status of the AI model based on results of monitoring.

Some other embodiments of the present application provide a method of supporting AI, e.g., a method performed in a UE, which includes: deploying at least one AI model, wherein a status of each AI model includes one of active status, inactive status or idle status; monitoring an AI model of the at least one AI model, wherein, the AI model is in the active status or the inactive status; and switching the status of the AI model based on results of monitoring.

In some embodiments of the present application, switching the AI model status is determined by the UE or indicated by a RAN node.

In some embodiments of the present application, switching the AI model status based on results of monitoring including: switching from the inactive status to the idle status or the active status; or switching from the active status to the idle status or the inactive status.

In some embodiments of the present application, monitoring the AI model includes: monitoring the AI model based on assistant data received from a RAN node.

According to some embodiments of the present application, the assistant data is requested from the RAN node, or is indicated by the RAN node with a signaling indicating switching the AI model status.

In some embodiments of the present application, the processor is configured to: report UE capability of AI model deployment; and receive the AI model from the RAN node.

According to some embodiments of the present application, reporting UE capability of AI model deployment is in response to receiving a query on the UE capability of AI model deployment from the RAN node.

In some embodiments of the present application, the processor is configured to: report description information of the AI model to the RAN node so that the RAN node can identify the AI model.

In some embodiments of the present application, in the case that switching the AI model status is indicated by the RAN node, the processor is configured to report results of monitoring the AI model.

According to some embodiments of the present application, the results of monitoring the AI model is reported in response to configured conditions being satisfied; or is reported periodically; or is reported in response to triggered events. Exemplary triggered events include at least one of the following: the AI model in the active status becomes worse than a threshold; the AI model in the inactive status becomes better than a threshold; the AI model in the inactive status outperforms another AI model in the active status than a threshold; or the AI model in the active status underperforms another AI model in the inactive status than a threshold.

According to some embodiments of the present application, the processor is configured to: transmit a signaling indicating switching the AI model from the idle status to the inactive status.

In some embodiments of the present application, in the case that switching the AI model status is determined by the UE, the processor is configured to: decide whether to switch the AI model from the idle status to the inactive status.

In some embodiments of the present application, the UE capability of AI model deployment includes at least one of the following: a maximum storage for AI models; or a maximum computation power for AI models.

In some embodiments of the present application, the UE capability of AI model deployment further includes at least one of the following: an ability to compile an open format model file; or an accelerator for neural network operations.

In some embodiments of the present application, in the case that there are a plurality of AI models in the UE, a maximum number of AI models that will be under monitoring, or inference, or both inference and monitoring is determined based on: storage limitation, computation power limitation and communication overhead.

Some other embodiments of the present application provide another apparatus of supporting AI, e.g., a RAN node, which includes: a transceiver; and a processor coupled to the transceiver, wherein the processor is configured to: transmit a signaling to a UE, indicating switching an AI model from a first status to a second status, wherein the first status is one of active status, inactive status or idle status and the second status is another one of the active status, inactive status or idle status; and receive results of monitoring the AI model from the UE in the case that the second status is the inactive status or the active status.

In some embodiments of the present application, the processor is configured to transmit assistant data for monitoring the AI model to the UE.

In some embodiments of the present application, the processor is configured to: receive UE capability of AI model deployment; and transmit the AI model to the UE.

According to some embodiments of the present application, the processor is configured to: transmit a query on the UE capability of AI model deployment before receiving the UE capability of AI model deployment.

In some embodiments of the present application, the processor is configured to: receive description information of the AI model from the UE so that the RAN node can identify the AI model.

In some embodiments of the present application, the processor is configured to: decide whether to switch the AI model to a status different from the second status based on the results of monitoring the AI model.

.Given the above, embodiments of the present application propose a technical solution of supporting AI in wireless communication, which solves the technical problem on how to manage and trigger AI model status switching in AI enhanced air interface. Accordingly, embodiments of the present application will facilitate the implementation of AI-based RAN.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 is a schematic diagram illustrating an exemplary wireless communication system according to some embodiments of the present application.

FIG. 2 is a schematic diagram illustrating an exemplary AI model status switching procedure according to some embodiments of the present application.

FIG. 3 is a flow chart illustrating an exemplary procedure of a method of supporting AI according to some embodiments of the present application.

FIG. 4 illustrates a flow chart of an exemplary procedure of a method of supporting AI in Cases A according to some embodiments of the present application.

FIG. 5 illustrates a flow chart of an exemplary procedure of a method of supporting AI in Cases A according to some other embodiments of the present application.

FIG. 6 illustrates a flow chart of an exemplary procedure of a method of supporting AI in Cases B according to some embodiments of the present application.

FIG. 7 illustrates a flow chart of an exemplary procedure of a method of supporting AI in Cases B according to some other embodiments of the present application.

FIG. 8 illustrates a block diagram of an apparatus of supporting AI according to some embodiments of the present application.

FIG. 9 illustrates a block diagram of an apparatus of supporting AI according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long-term evolution (LTE), and so on. It is contemplated that along with the developments of network architectures and new service scenarios, all embodiments in the present application are also applicable to similar technical problems. Moreover, the terminologies recited in the present application may change, which should not affect the principle of the present application.

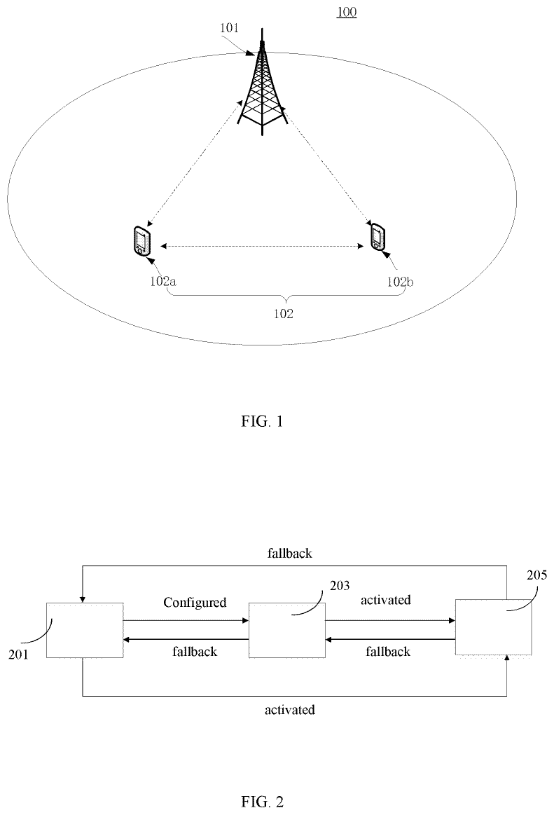

FIG. 1 illustrates a schematic diagram of an exemplary wireless communication system 100 according to some embodiments of the present application.

As shown in FIG. 1, the wireless communication system 100 includes at least one RAN node, e.g., base station (BS) 101 and at least one UE 102. In particular, the wireless communication system 100 includes one BS 101 and two UE 102 (e.g., a first UE 102a and a second UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

The UE 102, e.g., the first UE 102a and second UE 102b should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

3GPP has been considering introducing AI capability (or application) for communication since 2016. For example, 3GPP is discussing to introduce AI into air interface and some relevant objectives of the study item (SI) in the study item description (SID) are reproduced below:
for the use cases under consideration:
   assess potential specification impact, specifically for the agreed use cases in the final representative set and for a common framework:
      [symbol] physical (PHY) layer aspects, e.g., (RAN1):
         consider aspects related to, e.g., the potential specification of the AI Model lifecycle management, and dataset construction for training, validation and test for the selected use cases
         use case and collaboration level specific specification impact, such as new signalling, means for training and validation data assistance, assistance information, measurement, and feedback
      [symbol] Protocol aspects, e.g., (RAN2)-RAN2 only starts the work after there is sufficient progress on the use case study in RAN1
         consider aspects related to, e.g., capability indication, configuration and control procedures (training/inference), and management of data and AI/ML model, per RAN1 input
         collaboration level specific specification impact per use case.

In addition, according to RAN1 #110bis-e meeting, the data collection may be performed for different purposes in life-cycle management (LCM), including model training, model inference, model monitoring, model selection, model update, etc., each may be done with different requirements and have potential specification impact. Regarding LCM (or LCM procedure), it includes functionality-based LCM and model-ID-based LCM. That is, the LCM procedure is based on either functionality or model identity (ID) for the required operations, including activation, deactivation, switching and fallback etc.

Different AI models may support different functionalities, scenarios and/or configurations. For each AI model deployed in a device, i.e., UE, it is necessary to activate the corresponding AI models for identical or different purposes, e.g., inference and monitoring, considering the performance requirement, computation power, battery and so on.

Therefore, how to manage AI models and AI model status switching should be solved, especially for air interface, wherein, at least the following aspects are considered:
a) an AI model can be used for inference if conditions are satisfied, e.g., scenario and/or configuration well-matched;
b) some AI models need to be monitored for later inference;
c) different operations on an AI model, either inference or monitoring, have different process requirements; and
d) there are different UE capabilities, especially the ability to efficiently support AI models.

Given the above, embodiments of the present application propose technical solutions to support AI model status switching, e.g., a set of signalling over air interface, including AI model status definitions, switching configurations and relevant events to trigger status switching, which can satisfy AI model management requirements, e.g., generalization, latency and performance etc.

According to the agreed AI/ML-based approaches, there are two kinds of AI models: single-side, i.e., either in remote side (e.g., UE side) or network side (e.g., gNB side); and two-side, i.e., in both remote side and network side. In any approach, it is possible to transfer the AI model over the air interface (e.g., network and UE collaboration Level z). On the other hand, in the case that the AI model on one side (e.g., the remote side) needs to be managed, data, e.g., assistant data associated with the AI model may need to be transferred from the other side (e.g., the network side). Herein (throughout the specification), the illustrated embodiments of the present application only take AI models (or models, or AI/ML models etc.) deployed in the UE side as an example. The AI models deployed in the UE may be generated in the UE or transferred from other apparatus(es), e.g., transferred from an apparatus outside the network or not known by the network side, e.g., not known by a gNB.

Before an AI model will be deployed in the UE, the UE may report the UE capability of AI model deployment (or UE's AI capability etc.) to the network side, e.g., to a gNB. Exemplary UE capability of AI model deployment includes the maximum storage for AI models, or the maximum computation power for AI models, or both the maximum storage for AI models and maximum computation power for AI models etc. The maximum storage for AI models, e.g., the random access memory (RAM) size for AI model deployment can be used to calculate the maximum (or potential or possible) number of AI models for deployment. For example, in the case that AI model(s) will be transferred from the network side to the UE, the UE will report the available RAM size for AI model deployment before receiving the AI model(s). The maximum computation power for AI models, e.g., the number of digital signal processors (DSPs) and/or the number of multiply accumulates (MACs) for AI model deployment can be used to calculate the maximum number of AI models to be activated for inference and/or monitoring operations.

In some embodiments of the present application, the UE capability of AI model deployment may further include: ability to compile an open format model file, which indicates whether the UE can compile a model file or not; or accelerator for the neural network operation, which is descriptions on the hardware and software optimized for certain NN operations; or both the ability to compile an open format model file and accelerator for the neural network operation etc.

The UE capability of AI model deployment may be reported to the network side via a RRC signaling or other signaling. For example, the UE capability of AI model deployment may be carried by a new information element (IE) specifically designed for the UE capability of AI model deployment, e.g., “UE-AI-Capability,” or be carried by a current UE capability IE, e.g., “UE-NR-capability” enhanced to include the UE capability of AI model deployment. Accordingly, the following IE may be introduced or enhanced for the RRC signaling or other signaling in the specification related to air interface.

- UE-AI-Capability
The IE UE-AI-Capability is used to convey the UE Capability Parameters
to support AI.

UE-AI-Capability information element

-- ASN1START
-- TAG-UE-AI-CAPABILITY-START

| | |
|---|---|
| UE-AI-Capability ::= | SEQUENCE { |

| | |
|---|---|
| maxAI-Storage-r18 | INTEGER (1..16) |

OPTIONAL,

| | |
|---|---|
| maxAI-Compute-r18 | INTEGER (1..16) |

OPTIONAL,

| | |
|---|---|
| aiModelCompile_r18 | ENUMERATED {supported} |

OPTIONAL,

| | |
|---|---|
| aiAccelerator_r18 | ENUMERATED {supported} |

OPTIONAL
}
-- TAG-UE-AI-CAPABILITY-STOP
-- ASN1STOP

First, an exemplary new IE for the UE capability of AI model deployment, e.g., “UE-AI-Capability” is illustrated above. In the new IE, “maxAI-Storage-r18” means the maximum storage for AI models in Mega-byte (MB), “maxAI-Compute-r18” means the maximum computing power for AI operations in operations per second (OPS), “aiModelCompile_r18” mean whether the compiling ability is supported or not and “aiAccelerator_r18” mean whether the accelerator is supported or not.

Regarding enhancing the current UE capability IE to include the capability of AI model deployment, an exemplary enhanced “UE-NR-capability” IE is illustrated below, which includes information related to UE capability of AI model deployment, e.g., “maxAI-Storage-r18,” “maxAI-Compute-r18,” “aiModelCompile_r18” and “aiAccelerator_r18.”

- UE-NR-Capability

UE-NR-Capability information element

-- ASN1START
-- TAG-UE-NR-CAPABILITY-START

| | |
|---|---|
| UE-NR-Capability ::= | SEQUENCE { |

(Skip)

| | |
|---|---|
| AI-Parameters-r18 ::= | SEQUENCE { |

| | |
|---|---|
| maxAI-Storage-r18 | INTEGER (1..16) |

OPTIONAL,

| | |
|---|---|
| maxAI-Compute-r18 | INTEGER (1..16) |

OPTIONAL,

| | |
|---|---|
| aiModelCompile_r18 | ENUMERATED |

{supported}
OPTIONAL,

| | |
|---|---|
| aiAccelerator_r18 | ENUMERATED |

{supported}
OPTIONAL
...
}
-- TAG-UE-NR-CAPABILITY-STOP
-- ASN1STOP

According to some embodiments of the present application, there are multiple statuses (or states) of an AI model deployed in a device, e.g., active, inactive and idle status. An AI model can be switched in different statuses to support different application scenarios, so as to assist switching the AI model to be adaptive to the deployment scenarios to improve the generalization performance of the AI-based approaches.

FIG. 2 is a schematic diagram illustrating an exemplary AI model status switching procedure according to some embodiments of the present application, wherein switching among the idle status, inactive status and active status is shown.

Referring to FIG. 2, regarding the active status 201, it is defined as: if an AI model is in the active status 201, it means that the AI model is under use (or application), e.g., used for inference, and the output of the AI model can be also used for monitoring if needed. AI models in the active status 201 can be selected, deactivated or configured to switch or fallback for monitoring, e.g., to the inactive status 203; or switch or fallback to the idle status 205. Regarding the inactive status 203, it is defined as: if an AI model is in the inactive status 203, it means that the AI model is under monitoring only. AI model monitoring (or for monitoring purpose) may need dedicated configuration signaling and assistant data, e.g., ground-truth data collection to calculate the metric used for performance degradation measurement. AI models in the inactive status 203 can be selected, activated or configured to switch for inference, e.g., to the active status 201; or fallback or be deactivated to be idle, e.g., to the idle status 205. Regarding the idle status 205, it is defined as: if an AI model is in the idle status 205, it means that the AI model is neither under inference nor monitoring, but available in the device. An AI model in the idle status 205 can be selected, or be activated, or be configured to switch for inference, e.g., to the active status 201, or only for monitoring, e.g., to the inactivate status 203.

Persons skilled in the art should well know that the terms “active status,” “inactive status” and “idle status” are only used to describe each status in a simple and clear manner, and may be replaced by other terms and thus should not be used to unduly limit the scope of the present application.

In addition, an AI model in different statuses may have different operation complexities. For example, requirements on the operations of an AI model in different statuses are summarized in Table 1 below, where OP_{act}≈OP_{inact}, and OPidle≈0.

TABLE 1

| | | | Whether additional |
|---|---|---|---|
| AI model | Model | Computation | configuration on assistant |
| status | size | complexity | data needed for monitoring |
| Active | N_{size} | OP_{act} | No |
| Inactive | N_{size} | OP_{inact} | Yes |
| Idle | N_{size} | OP_{idle} | No |

In the case that there are multiple AI models in a device, the maximum number of AI models that will be under inference and/or monitoring (e.g., inference, or monitoring, or both inference and monitoring) is determined based on: storage limitation, computation power limitation and communication overhead. That is, limited by the local computation power and communication resources for AI inference and/or monitoring, in some cases, only partial AI models can be activated for inference and/or monitoring. For example, the following conditions will be satisfied to support the AI models under inference and/or monitoring:
storage limitation:

$${\sum }_{k = 0}^{K - 1} {N}_{size}^{( k )} \leq {N}_{mem} ,$$

where Nₘₑₘ is the maximum storage to store AI models;
computation power limitation:

$${\sum }_{k = 0}^{K - 1} 〈 {OP}_{act}^{( k )} \vert {OP}_{inact}^{( k )} \vert {OP}_{idle}^{( k )} 〉 \leq OPS \cdot T ,$$

where [symbol] ⋅|⋅|⋅ [symbol] means to select one from the three elements, and OPS is the maximum computation power of the device in number of operations per second, and Tis the required processing time; and it is necessary for UE to schedule the computation resource to select the models to be in different statuses, which may be needed for further configuration from network; and
communication overhead: communication resources for transferring the assistant data for AI model monitoring should satisfy throughput and latency etc. communication requirements.

According to some embodiments of the present application, AI model status can be switched under the control or management of UE (also referred to as “UE trigger”) or under the control or management of the network (also referred to as “network trigger”).

For example, in the case of UE trigger, if there are enough available local computation resources, UE can try to switch an AI model from the idle status to the inactive status for monitoring, which may not need dedicated signaling. If there are not enough communication resources available for monitoring (or there are other limitations), the switching from the idle status to the inactive status will fail, and the AI model will keep in the idle status, which needs one or more dedicated signaling to apply the communication resources. If the performance of an AI model, e.g., Model #1, in the inactive status is monitored to be better than the current one in the active status, e.g., Model #2, Model #1 be switched from the inactive status to the active status for inference, and Model #2 will be switched from the activate status to the inactive status or even to the idle status. More computation resources and communication resources available, more AI models can be switched from the idle status into the inactive status for monitoring to better improve the generalization performance.

In the case of network trigger, according to the description information of an AI model(s), if the deployment scenario is detected, the network can indicate the UE to switch the AI model(s) from the idle status to the inactive status for monitoring. The signaling from the network indicating or triggering UE to switch the AI model to the inactivate status for monitoring can be pre-configured, e.g., in a periodical manner, or be event-triggered. The UE will report the monitoring results to the network, e.g., reporting the gap between the outputs and the ground-truth values, prediction accuracy, and the number of error results etc. According to the reported monitoring results, the network will indicate the UE to select and switch the AI model(s) to the activate status for inference (including monitoring).

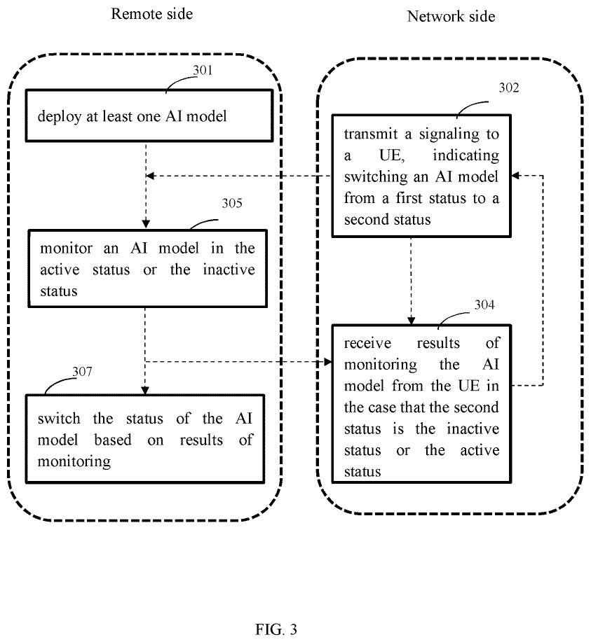

FIG. 3 illustrates a flow chart of an exemplary procedure of a method of supporting AI according to some embodiments of the present application. Although the method is illustrated in a system level by two apparatus of supporting AI, e.g., UE or the like in the remote side and a RAN node, e.g., gNB or the like in the network side, persons skilled in the art would understand that the method implemented in each apparatus can be separately implemented and incorporated by other apparatus with similar functions. In addition, no transmission or reception failure is considered in the illustrated embodiments of the present application.

Referring to FIG. 3, in step 301, at least one AI model will be deployed in the UE. Different AI models may be deployed in the same or different manners. For example, an AI model may be generated (or constructed) in the UE or is transferred from other apparatus, e.g., a gNB or an apparatus outside the network. The status of each AI model may be an active status, inactive status or idle status. In some embodiments of the present application, a deployed AI model will be default in the idle status, and then will be switched to the inactive status for monitoring or even directly to the active status for inference and monitoring.

In the case that AI model status switching is managed by the UE itself, the UE will decide the status of each AI model deployed in the UE. In the case that AI model status switching is managed by the network, the network will decide the status of each AI model deployed in the UE and transmit a signaling indicating AI model status switching in step 302, e.g., switching an AI model from a first status to a second status, wherein the first status is one of active status, inactive status or idle status and the second status is another one of the active status, inactive status or idle status. For example, the network will indicate the UE to switch an idle AI model (AI model in idle status) to an inactive AI model (AI model in inactive status) or even to an active AI model (AI model in active status).

For each AI model in the active status or the inactive status, the UE will monitor the AI model in step 303. In the case of network trigger, the UE will report the results of monitoring to the network. For example, the UE will report the results of monitoring in response to configured conditions being satisfied; or report the results of monitoring periodically; or report the results of monitoring in response to triggered events. Exemplary triggered events include at least one of the following: the AI model in the active status becomes worse than a threshold, the AI model in the inactive status becomes better than a threshold, the AI model in the inactive status outperforms another AI model in the active status than a threshold, or the AI model in the active status underperforms another AI model in the inactive status than a threshold. Accordingly, the network will receive the reported monitoring results in step 304.

Based on results of monitoring, if it is necessary (decided by the UE itself in the case of UE trigger or decided by the network in the case of network trigger), the status of the AI model will be switched in step 305. For example, the AI model in the inactive status may be switched to the active status if the results of monitoring show that the AI model becomes better than a threshold or better than an active AI model. For another example, the AI model in the inactive status may fallback to the idle status if the results of monitoring show the AI model becomes worse than a threshold. For yet another example, the AI model in the active status may be switched to the inactive status or even deactivated to the idle status if the results of monitoring show the AI model becomes worse than a threshold, or worse than an inactive AI model.

More detailed embodiments of the present application will be illustrated in the following in view of status switching of the AI model(s) deployed in the UE (also referred to as “UE-part models” or “UE-sided models”) under UE trigger or network trigger. In addition, although in each case (network trigger or UE trigger), the AI models in the UE transferred from the network or not are separately illustrated for clearness, persons skilled in the art should well know that the AI models in the UE may be transferred from the network or not in the same case.

### Cases A: Network Trigger

According to some embodiments of the present application, the UE-part AI models or UE-sided AI models are transferred from the network, e.g., a gNB, and managed by the network. Before transferring the AI models to the UE, the network needs to know the UE capability of AI model deployment. The UE may report its capability of AI model deployment on its own initiative or in response to the request (or query) from the network, e.g., a gNB.

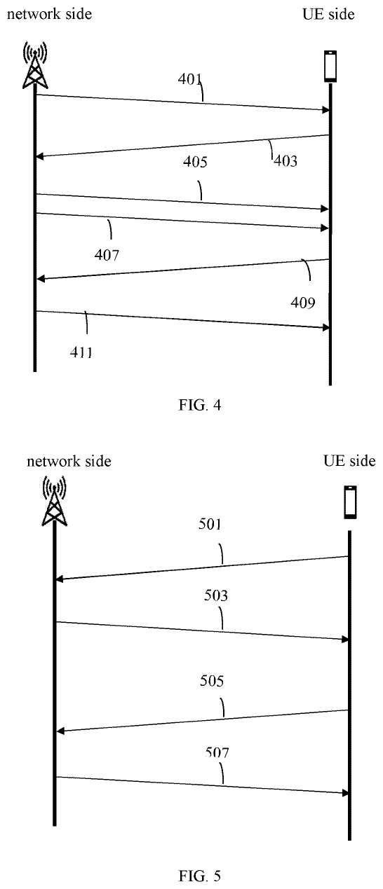

FIG. 4 illustrates a flow chart of an exemplary procedure of a method of supporting AI in Cases A according to some embodiments of the present application. It is assumed that one or more AI models deployed in the UE are transferred from the network.

Referring to FIG. 4, in step 401, the network, e.g., a gNB may ask for the UE capability of AI model deployment, e.g., by transmitting a query or request on the UE capability of AI model deployment via a RRC signaling or the like.

In response to the request, the UE will report its capability of AI model deployment to the gNB in step 403, which can be used for reference for the following model deployment (or transfer). As stated above, the UE may report its capability of AI model via a RRC signaling or other signaling, including an enhanced IE “UE-NR-Capability” or a new IE “UE-AI-Capability” or the like.

There is one or more AI models stored in (or deployed in) the network, e.g., in an AI model repository or pool of the gNB. The gNB will transfer partial or all of the stored AI models to the UE in various manners in step 405, e.g., via an IE “AI-ModelTransfer” or the like that may be introduced for the RRC signaling in the specification related to air interface. In some embodiments of the present application, no matter which manner is used to transfer the AI models, the number of AI models will be decided by the UE capability of AI model deployment. In addition, when transferring the AI models to the UE, the model ID will be correspondingly decided and assigned to identify each AI model for the following operations.

In some embodiments of the present application, all the transferred AI models to the UE in step 405 are default in the idle status. Based on the available information of the transferred models, the gNB can configure the AI models for management in step 407, e.g., switching partial or all of the AI models from the idle status to the inactive status for monitoring, e.g., by indicating the corresponding model IDs. For example, Models #0, #1, #2, #3 and #4 are transferred to the UE, while the gNB only indicates Models #1, #2 and #3 to the UE so that Models #1, 2 and 3 are enabled for monitoring to derive the output. In some embodiments of the present application, if assistant data for monitoring these AI models are available, the assistant data will also be transferred to the UE in step 407 or separately. After receiving the configuration or signaling, the UE will switch the status of related AI models as indicated and monitor the AI models in the inactive status or active status based on the assistant data (if any). In some cases, the AI models configured in the inactive status or active status may exceed the maximum number that can be supported by the UE due to the computation and communication resource limitation etc. as state above, the switching may fail and the UE will report to the network. Herein (including the following embodiments), only the successful switching is considered.

In some other embodiments of the present application, when transferring the AI models to the UE in step 405, the network may configure the AI models to be in any one of the idle status, inactive status and active status based on the available information of the AI models. That is, step 405 and step 407 can be combined into one step.

In step 409, the monitoring results will be reported to the network for further status switching decision, which may include the gap between the outputs and the ground-truth values, prediction accuracy, and the number of error results etc. As stated above, reporting the monitoring results will be periodically, or in the case of configured conditions being satisfied or configured or predefined event being triggered.

Based on the reported monitoring results, the gNB will make a status switching decision and indicate the decision to the UE in step 411. In some embodiments of the present application, according to the reported results, the AI models used for inference will be selected, e.g., the AI models in the inactive status that are monitored with the best performance, and then indicated to the UE. In some other embodiments of the present application, according to the reported results, the network may indicate AI models in the inactive status to be switched to the idle status, e.g., the AI models in the inactive status that are monitored with the worst performance. In some yet other embodiments of the present application, the network may indicate both AI models to be switched to the active status and idle status. For example, based on the reported monitoring results of Models #1, 2, and 3 (if any), the network indicates to the UE to switch model #1 to the active status for inference. Models #2 and 3 may still remain in the inactive status, or be indicated to switch to the idle status. In some cases, the network will also configure the idle AI models, e.g., Models #0 and 4 to the inactive status or active status if more AI models are needed for monitoring and/or inference or the currently monitored AI models do not perform well. The network may also transmit assistant data for inference to the UE in the case that one or more AI models are activated to the active status.

The UE will use the AI models in the active status for inference and monitor the AI models in the inactive status or in active status. The network may further transmit assistant data to the UE for monitoring in some cases if the updated assistant data is available. Similarly, in the following operations, the UE will continuously report the AI models monitoring results periodically, or in the case of configured conditions being satisfied or events being triggered. The network will receive the monitoring results of the AI models and manage the AI models based on the reported monitoring results. In the cases that more AI models are needed or the currently monitored AI models do not perform well, the network will also configure the idle AI model to the inactive status or active status. For example, Model #0 is in the idle status, Model #1 is in the inactive status and Model #2 is in the active status. If the received monitoring results show that the performance of an AI model, e.g., Model #1, in the inactive status is better than the current one in the active status, e.g., Model #2, the network will decide to switch Model #1 from the inactive status to the active status for inference, and switch Model #2 from the activate status to the inactive status or even to the idle status. If one or both of Models #1 and Models #2 are bad in performance, the network may decide to switch Model #0 from the idle status to the inactive status or even directly to the active status.

According to some other embodiments of the present application, the UE-part AI models or UE-sided AI models are also managed by the network, e.g., by a gNB, while the UE-part AI models or UE-sided AI models are generated by the UE or transferred from other apparatus, e.g., an apparatus outside the network. That is, the apparatus in the network side, e.g., a gNB that will manage the UE-part AI models or UE-sided AI models has no idea on the UE-part AI models or UE-sided AI models. The UE needs to report the information, e.g., description information of the UE-part AI models or UE-sided AI models to the network side.

FIG. 5 illustrates a flow chart of an exemplary procedure of a method of supporting AI in Cases A according to some other embodiments of the present application. It is assumed that the one or more AI models deployed in the UE are not known by the network, e.g., a gNB that will manage the one or more AI models.

Referring to FIG. 5, there is one or more AI models deployed in UE, e.g., in an AI model repository or pool of the UE, which are default in the idle status. In step 501, the UE will report description information of partial or all of the UE-part AI models or UE-sided AI models to the gNB, so that the RAN node can identify (or register) the UE-part AI models or UE-sided AI models. Exemplary description information of each AI model may include the functionality, input/output data and what assistant data is needed etc. Each AI model from the UE can be still identified with the same ID in the UE or identified with new ID assigned by the network.

Based on the description information of the UE-part AI models or UE-sided AI models, the network will decide the status of each AI models. For example, the network will select partial or all of the AI models deployed in the UE to be monitored and configure them to switch from the idle status to the inactive status in step 503. In some cases, the gNB may also send the available assistant data for the AI models to be monitored to the UE in step 503 or in a separate step. For example, the gNB may indicate that Models #1, 2 and 3 are enabled for monitoring to derive the outputs, and send the assistant data to the UE to assist the model monitoring.

Similar to step 409, the monitoring results will be reported to the network for status switching decision in some cases in step 505, which may include the gap between the outputs and the ground-truth values, prediction accuracy, and the number of error results etc. As stated above, reporting the monitoring results will be periodically, or in the case of configured conditions being satisfied or configured or predefined event being triggered.

Based on the reported monitoring results, the gNB will make a status switching decision and indicate the decision to the UE in step 507, which is similar to step 411 and will not repeat for simplification.

The following operations are also similar to those illustrated in FIG. 4 and will not repeat for simplification.

### Cases B: UE Trigger

According to some embodiments of the present application, the UE-part AI models or UE-sided AI models are transferred from the network, e.g., a gNB, and managed by the UE. Before transferring the AI models to the UE, the network needs to know the UE capability of AI model deployment. The UE may report its capability of AI model deployment on its own initiative or in response to the request (or query) from the network, e.g., a gNB.

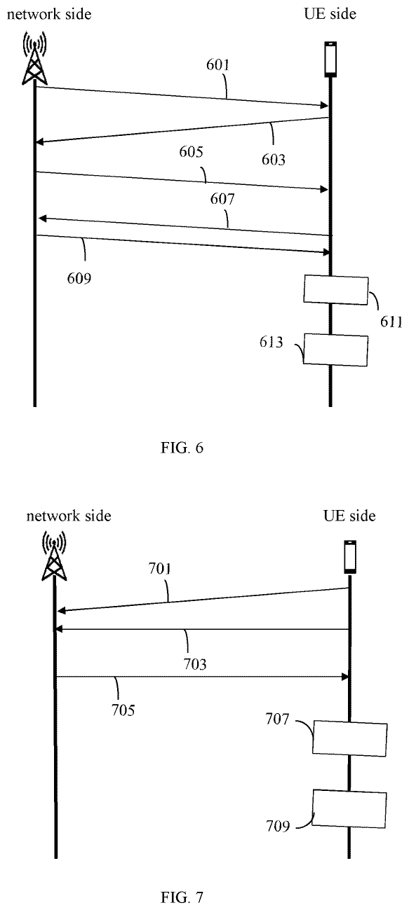

FIG. 6 illustrates a flow chart of an exemplary procedure of a method of supporting AI in Cases B according to some embodiments of the present application. It is assumed that one or more AI models deployed in the UE are transferred from the network.

Referring to FIG. 6, in step 601, the network, e.g., a gNB may ask for the UE capability of AI model deployment, e.g., by transmitting a query or request on the UE capability of AI model deployment via a RRC signaling or the like.

In response to the request, the UE will report its capability of AI model deployment to the gNB in step 603, which can be used for reference for the following AI model deployment (or AI model transfer). As stated above, the UE may report its capability of AI model via a RRC signaling or other signaling, including an enhanced IE “UE-NR-Capability” or a new IE “UE-AI-Capability” or the like.

There is one or more AI models stored in (or deployed in) the network, e.g., in an AI model repository or pool of the gNB. The gNB will transfer partial or all of the stored AI models to the UE in various manners in step 605, e.g., via an IE “AI-ModelTransfer” or the like that may be introduced for the RRC signaling in the specification related to air interface. In some embodiments of the present application, no matter which manner is used to transfer the AI models, the number of AI models will be decided by the UE capability of AI model deployment. In addition, when transferring the AI models to the UE, the ID information of the AI models will be correspondingly decided and assigned to identify each AI model.

In some embodiments of the present application, all the transferred AI models to the UE in step 605 are default in the idle status. After receiving the AI models, the UE will decide which AI model(s) is in the active, inactive or idle status via a UE trigger procedure, which does not depend on the assistant data for monitoring from the network. For example, the UE may switch partial or all of the AI models from the idle status to the inactive status for monitoring.

If assistant data is needed for monitoring of certain AI model(s), the UE will request the assistant data for the certain AI models from the network in step 607, e.g., indicating dedicated model ID(s) to the network for the corresponding data. After receiving the request on the assistant data, the network will send the requested assistant data (if available) to the UE in step 609. In step 611, the UE will monitor the AI models in the inactive status with the assistant data (if any).

Based on the monitoring results, e.g., the gap between the outputs and the ground-truth values, prediction accuracy, and the number of error results etc., the UE will make a status switching decision in step 613. In some embodiments of the present application, according to the monitoring results, the AI models used for inference will be selected, e.g., the AI models in the inactive status that are monitored with the best performance. In some other embodiments of the present application, according to the monitoring results, the UE may decide to switch the AI models in the inactive status to the idle status, e.g., the AI models in the inactive status that are monitored with the worst performance. In some yet other embodiments of the present application, the UE will may configure the idle AI models to the inactive status or active status if more AI models are needed for monitoring and/or inference or the currently monitored AI models do not perform well.

The UE will use the AI models in the active status for inference and monitoring the AI models in inactive status or in active status. If additional assistant data for monitoring and/or inference is needed, the UE will request them from the network. Similarly, the UE will further manage the AI models based on the monitoring results. In the cases that more AI models are needed or the currently monitored AI models do not perform well, the UE will also configure the idle AI model to the inactive status or active status. For example, Model #0 is in the idle status, Model #1 is in the inactive status and Model #2 is in the active status. If the performance of an AI model, e.g., Model #1, in the inactive status is monitored to be better than the current one in the active status, e.g., Model #2, the UE will decide to switch Model #1 from the inactive status to the active status for inference, and switch Model #2 from the activate status to the inactive status or even to the idle status. If one or both of Models #1 and Models #2 are bad in performance, the UE may decide to switch Model #0 from idle status to inactive status or even to active status.

According to some other embodiments of the present application, the UE-part AI models or UE-sided AI models are also managed by the UE, e.g., by a serving gNB, while the UE-part AI models or UE-sided AI models are generated by the UE or transferred from other apparatus, e.g., an apparatus outside the network. The network side has no idea on the UE-part AI models or UE-sided AI models. The UE needs to report the information, e.g., description information of the UE-part AI models or UE-sided AI models to the network side.

FIG. 7 illustrates a flow chart of an exemplary procedure of a method of supporting AI in Cases B according to some other embodiments of the present application. It is assumed that the one or more AI models deployed in the UE are not known by the network.

Referring to FIG. 7, there is one or more AI models deployed in UE, e.g., in an AI model repository or pool of the UE, which are default in the idle status. In step 701, the UE will report description information of partial or all of the UE-part AI models or UE-sided AI models to the gNB, so that the RAN node can identify (or register) the UE-part AI models or UE-sided AI models. Whatever, description information of an AI model in the UE will be reported to the network before it is monitored. Exemplary description information of each AI model may include the functionality, input/output data and needed assistant data etc. Each AI model from the UE can be still identified with the same ID in the UE or identified with new ID assigned by the network.

The UE will decide which AI model(s) is in the active, inactive or idle status via a UE trigger procedure, which does not depend on the assistant data for monitoring from the network. For example, the UE may switch partial or all of the AI models from the idle status to the inactive status for monitoring.

If there is assistant data is needed for monitoring of certain AI model(s), the UE will request the assistant data for the certain AI models from the network in step 703, e.g., indicating dedicated model ID(s) to the network for the corresponding data. After receiving the request on the assistant data, the network will send the requested assistant data (if available) to the UE in step 705. The UE will monitor the AI models in the inactive status with the assistant data (if any) in step 707.

In some embodiments of the present application, e.g. the description information of each AI model indicates what assistant data is needed, the network may directly transmit the available assistant data to the UE regardless whether a request of assistant data is received.

Based on the monitoring results, e.g., the gap between the outputs and the ground-truth values, prediction accuracy, and the number of error results etc., the UE will make a status switching decision in step 709, which is similar to step 613 and will not repeat for simplification.

The following operations are also similar to those illustrated in FIG. 6 and will not repeat for simplification.

Besides the methods, embodiments of the present application also propose an apparatus of supporting AI.

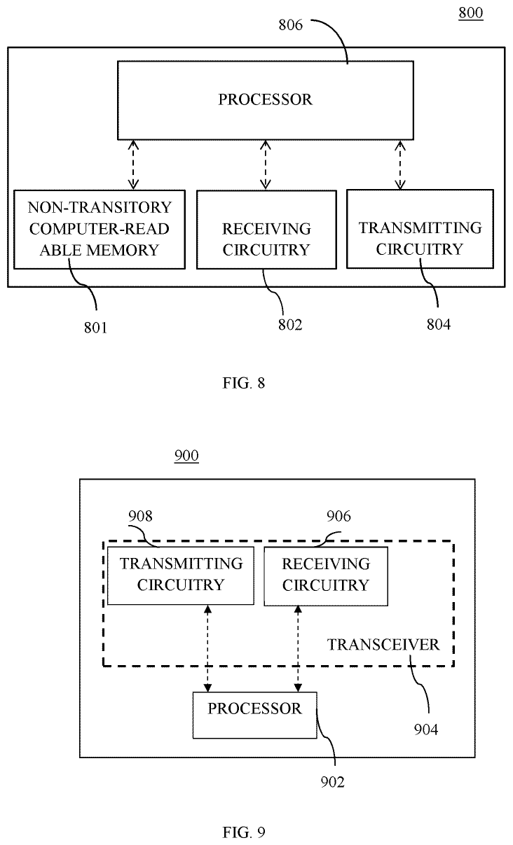

For example, FIG. 8 illustrates a block diagram of an apparatus of supporting AI 600 according to some embodiments of the present application.

As shown in FIG. 8, the apparatus 800 may include at least one non-transitory computer-readable medium 801, at least one receiving circuitry 802, at least one transmitting circuitry 804, and at least one processor 806 coupled to the non-transitory computer-readable medium 801, the receiving circuitry 802 and the transmitting circuitry 804. The at least one processor 806 may be a central processing unit (CPU), a DSP, a microprocessor etc. The apparatus 800 may be a RAN node, e.g., a gNB or a remote apparatus, e.g., a UE configured to perform a method illustrated in the above or the like.

Although in this figure, elements such as the at least one processor 806, transmitting circuitry 804, and receiving circuitry 802 are described in the singular, the plural is contemplated unless a limitation to the singular is explicitly stated. In some embodiments of the present application, the receiving circuitry 802 and the transmitting circuitry 804 can be combined into a single device, such as a transceiver. In certain embodiments of the present application, the apparatus 800 may further include an input device, a memory, and/or other components.

In some embodiments of the present application, the non-transitory computer-readable medium 801 may have stored thereon computer-executable instructions to cause a processor to implement the method with respect to the RAN node, e.g., the gNB as described above. For example, the computer-executable instructions, when executed, cause the processor 806 interacting with receiving circuitry 802 and transmitting circuitry 804, so as to perform the steps with respect to the RAN node as depicted above.

In some embodiments of the present application, the non-transitory computer-readable medium 801 may have stored thereon computer-executable instructions to cause a processor to implement the method with respect to the remote apparatus, e.g., the UE as described above. For example, the computer-executable instructions, when executed, cause the processor 806 interacting with receiving circuitry 802 and transmitting circuitry 804, so as to perform the steps with respect to the remote apparatus as illustrated above.

FIG. 9 is a block diagram of an apparatus of supporting AI 900 according to some other embodiments of the present application.

Referring to FIG. 9, the apparatus 900, for example a RAN node or a UE may include at least one processor 902 and at least one transceiver 904 coupled to the at least one processor 902. The transceiver 904 may include at least one separate receiving circuitry 906 and transmitting circuitry 904, or at least one integrated receiving circuitry 906 and transmitting circuitry 904. The at least one processor 902 may be a CPU, a DSP, a microprocessor etc.

According to some embodiments of the present application, the apparatus 900 is a UE, which includes: a transceiver; and a processor coupled to the transceiver, wherein the processor is configured to: deploy at least one AI model, wherein a status of each AI model includes one of active status, inactive status or idle status; monitor an AI model of the at least one AI model, wherein, the AI model is in the active status or the inactive status; and switch the status of the AI model based on results of monitoring.

According to some embodiments of the present application, the apparatus 900 is a RAN node, which includes: a transceiver; and a processor coupled to the transceiver, wherein the processor is configured to: transmit a signaling to a UE, indicating switching an AI model from a first status to a second status, wherein the first status is one of active status, inactive status or idle status and the second status is another one of the active status, inactive status or idle status; and receive results of monitoring the AI model from the UE in the case that the second status is the inactive status or the active status.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, read only memory (ROMs), flash memory, electrically erasable programmable read only memory (EEPROMs), optical storage devices (compact disc (CD) or digital video disc (DVD)), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE) for wireless communication, comprising:
at least one memory; and
at least one processor coupled with the at least one memory and configured to cause the UE to:
deploy at least one artificial intelligence (AI) model, wherein a status of each AI model includes one of active status, inactive status, or idle status;
monitor an AI model of the at least one AI model, wherein the AI model is in the active status or the inactive status; and
switch the status of the AI model based at least in part on results of monitoring.

2. The UE of claim 1, wherein switching the status of the AI model is determined by the UE or indicated by a radio access network (RAN) node.

3. The UE of claim 1, wherein the at least one processor is configured to cause the UE to monitor the AI model based at least in part on assistant data received from a radio access network (RAN) node.

4. The UE of claim 3, wherein the assistant data is requested from the RAN node, or is indicated by the RAN node with a signaling indicating to switch the status of the AI model.

5. The UE of claim 1, wherein the at least one processor is configured to cause the UE to:
report UE capability of AI model deployment; and
receive the AI model from a radio access network (RAN) node.

6. The UE of claim 5, wherein the at least one processor is configured to cause the UE to report the UE capability of the AI model deployment in response to receiving a query on the UE capability of the AI model deployment from the RAN node.

7. The UE of claim 1, wherein the at least one processor is configured to cause the UE to report description information of the AI model to a radio access network (RAN) node so that the RAN node can identify the AI model.

8. The UE of claim 1, wherein, if switching the status of the AI model is indicated by a radio access network (RAN) node, the at least one processor is configured to cause the UE to report the results of the monitoring the AI model.

9. The UE of claim 8, wherein the results of the monitoring the AI model is at least one of reported in response to configured conditions being satisfied, reported periodically, or reported in response to triggered events.

10. The UE of claim 9, wherein the triggered events comprise at least one of:
the AI model in the active status becomes worse than a threshold;
the AI model in the inactive status becomes better than the threshold;
the AI model in the inactive status outperforms another AI model in the active status; or
the AI model in the active status underperforms the another AI model in the inactive status.

11. The UE of claim 5, wherein the UE capability of the AI model deployment comprises at least one of:
a maximum storage for AI models; or
a maximum computation power for the AI models.

12. The UE of claim 1, wherein, for a plurality of AI models in the UE, a maximum number of the plurality of AI models that will be at least one of monitored or inference is determined based on storage limitation, computation power limitation, and communication overhead.

13. A radio access network (RAN) node for wireless communication, comprising:
at least one memory; and
at least one processor coupled with the at least one memory and configured to cause the RAN node to:
transmit, to a user equipment (UE), a signaling indicating switching an artificial intelligence (AI) model from a first status to a second status, wherein the first status is one of active status, inactive status, or idle status and the second status is another one of the active status, inactive status, or idle status; and
receive, from the UE, results of monitoring the AI model if the second status is the inactive status or the active status.

14. The RAN node of claim 13, wherein the at least one processor is configured to cause the RAN node to determine whether to switch the AI model to a status different from than the second status based at least in part on the results of monitoring the AI model.

15. A method performed by a user equipment (UE), the method comprising:
deploying at least one artificial intelligence (AI) model, wherein a status of each AI model includes one of active status, inactive status, or idle status;
monitoring an AI model of the at least one AI model, wherein the AI model is in the active status or the inactive status; and
switching the status of the AI model based at least in part on results of the monitoring.

16. The method of claim 15, wherein the switching the status of the AI model is determined by the UE or indicated by a radio access network (RAN) node.

17. The method of claim 15, further comprising:
monitoring the AI model based at least in part on assistant data received from a radio access network (RAN) node.

18. The method of claim 17, wherein the assistant data is requested from the RAN node, or is indicated by the RAN node with a signaling indicating to switch the status of the AI model.

19. The method of claim 15, further comprising:
reporting UE capability of AI model deployment; and
receiving the AI model from a radio access network (RAN) node.

20. A method performed by a radio access network (RAN) node, the method comprising:
transmitting, to a user equipment (UE), a signaling indicating switching an artificial intelligence (AI) model from a first status to a second status, wherein the first status is one of active status, inactive status, or idle status and the second status is another one of the active status, inactive status, or idle status; and
receiving, from the UE, results of monitoring the AI model if the second status is the inactive status or the active status.
